(19) United States
(12) Patent Application Publication
(10) Pub. No.: US 2007/0227363 A1
(43) Pub. Date: Oct. 4, 2007

(54) Espresso coffee-making machine and associated method

(76) Inventor: Raffaello Verna, Creedmoor, NC (US)

Correspondence Address: Verna Design, Inc, 3189 Hardie St, Creedmoor, NC, 27522, US

(21) Appl. No.: 11/732,387

(22) Filed: Apr. 3, 2007

Related U.S. Application Data
(60) Provisional application No. 60/788,835, filed on Apr. 3, 2006.

(51) Int. Cl. A47J 31/44

(52) U.S. Cl. 99/279

(57) ABSTRACT

An espresso-coffee making apparatus comprising a brew water tank at least one heating device for the purpose of heating the brew water, and a pump operatively engaged to the brew water tank with both its inlet and outlet. The pump outlet is attached to a housing such that the pump's discharge moves past the heating device for effective mixing at the heat source. The housing may also include turbulators for further enhanced mixing. Thus, maximum temperature homogeneity within the brew water tank is achieved. The apparatus may further comprise a biasing device operatively engaged to a piston-type pump via a linkage mechanism. Wherein the biasing device is energized by the operator, by means of a lever and the pressurized water produced used to brew espresso. Further, the pressure of the water produced by the pump is modified by the linkage mechanism such that the brew pressure as a function of displaced liquid is controlled. Thus more optimal brewing pressure profiles can be achieved.

### CROSS REFERENCE TO RELATED APPLICATIONS

This application claims the benefit of U.S. Provisional Application No. 60/788,835, filed 3 Apr. 2006.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of the Invention

The present invention relates to coffee-making machines and, more particularly, to an espresso coffee-making machine and associated method.

2. Description of Related Art

Espresso is a coffee-based beverage prepared at the time of consumption typically in single or double servings. It is loosely defined as the liquid product of forcing a quantity of water at high pressure and temperature through a quantity of roasted and ground coffee beans. Water temperatures and pressures used to make espresso vary widely but are generally near 93 degrees Celsius and 9 Bars. This definition is, and must be, loosely defined in terms of water quantity, temperature, and pressure and of quantity and preparation of the coffee itself because of the large number of variables in the brewing process, all of which can affect the taste of the beverage.

Espresso coffee is essentially a pleasure drink, having little in the way of dietary value. As such, its taste is of primary concern during its preparation. This presents a difficulty to its production. The immense number of taste-affecting variables all must be chosen to satisfy the highly subjective matter of one's taste. The beauty in this matter is that there is no single correct way to brew espresso; the bane is that the ability to consistently reproduce a desired taste is very challenging due to the loose control over the large number of variables.

It has been found that very small changes (i.e., less than 1 degree Fahrenheit) in the temperature of brewing water for espresso coffee can often be easily tasted in the beverage. Therefore, in order to achieve consistent results during the brewing process, very tight temperature control must be held over the brew water. In some espresso machines, a sophisticated temperature control system is employed to control the heating device for heating the brew water in the brew water tank to a selected temperature. However, since the heating device interacts with the brew water in a localized manner, there may exist temperature gradients in the brew water within the brew water tank. That is, the water nearest the heat source(s) will be hottest, while convective flow generated by these heat sources will lead to warmer water at the top of the tank than at the bottom. The point of temperature measurement for feedback to the controller used to control the temperature of the water in the tank may thus be at a different temperature than the water adjacent to the heating elements and, more importantly, at a different temperature than the temperature of the water at the brew outlet of the tank, where water is removed and directed to brew the coffee. All of the aforementioned issues have the net effect of making it exceedingly difficult to reproduce a particular temperature in the brew water.

In addition, some lever-operated spring-driven espresso machines have springs which the operator compresses by use of a lever assembly, wherein these springs act directly on a hydraulic piston for generating the pressure necessary for brewing espresso coffee. However, such machines are constrained to a particular brew pressure profile, or brew pressure as a function of time (or displaced volume), that is directly related to the force applied on the piston by the spring, which is to say, most often a linearly decreasing pressure finishing at a value of approximately half that at which it started. The desired brew pressure profile for any given espresso coffee can vary, however, and the constraint of such machines to a single, falling, brew-pressure profile could result in a less-than-optimal taste for a particular espresso coffee.

Thus, there exists a need for an espresso coffee machine for addressing, improving upon, and/or overcoming such issues, as previously discussed, that may be exhibited by existing devices.

### BRIEF SUMMARY OF THE INVENTION

The above and other needs are met by the present invention. The present invention makes improvements which can generally be grouped into two categories critical to the proper production of espresso: brew water temperature management and pressure management of brew water while brewing.

In the former category, brew water temperature management, the present invention makes improvements in the stability and repeatability of brew water temperature. In one embodiment, the present invention comprises a brew water tank, which may be cylindrical, prismatic, or any other shape suitable for containing the brewing water, at least one heating device for the purpose of heating the brew water, and an apparatus for creating turbulence, agitation, and/or mixing of the brew water for the machine, within the brew water tank, such that a high degree of homogeneity in the brew water temperature within the brew water tank is achieved. In one embodiment such agitation could be created by a pump which could be disposed inside, outside, or attached to the wall of the brew tank. In such instances, the pump would have an inlet to receive brew water from the tank and an outlet such that discharge from the pump is directed into the brew tank in such a manner that the pump discharge mixes with the tank content, and provides a homogeneous water temperature within the tank.

In still another embodiment, a pump is disposed inside, outside, or attached to the brew water tank with an associated inlet and outlet. The pump outlet is attached to a housing such that the water discharged from the pump outlet is forced to move past the heating device so that more effective mixing is achieved at the location of the heat sources, where the largest temperature gradients are likely to occur. The housing may also include turbulators therein or any other suitable device shaped and positioned such that the mixing of the water is enhanced by the presence thereof.

In the latter category, pressure management of brew water while brewing, the present invention makes improvements in the profiling (pressure versus displaced volume) and adjustability of brew pressure. In one embodiment the present invention, comprises a cylinder and a piston operatively engaged therein. Said piston can be driven to a second position by the operator by means of an operatively engaged lever when in the act of brewing espresso. Additionally, a linkage mechanism is operatively engaged to the piston and further configured to interact with a biasing device. The linkage and bias device as a whole being configured such that a bias forces acts on the piston biasing it from the second to the first position. The brew pressure generated is a function of the force supplied by bias device and the geometric relationship of the members of the linkage mechanism and piston. Another aspect of the present invention comprises the biasing device wherein such a biasing device includes a mechanism for adjusting the bias force of the device for the purpose of allowing the operator to change the brew pressure magnitude within some available range.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A is a schematic cross-sectional view of an espresso coffee making apparatus with the associated brew pressure mechanism in an idle position, according to one embodiment of the present invention

FIG. 1B is a schematic cross-sectional view of an espresso coffee making apparatus with the associated brew pressure mechanism in the “cocked” ready-to-brew position, according to one embodiment of the present invention.

### DETAILED DESCRIPTION OF THE INVENTION

The present invention will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

The present invention comprises an espresso machine with a number of novel features which, singularly or in combination, are capable of contributing to the production of an improved cup of espresso coffee.

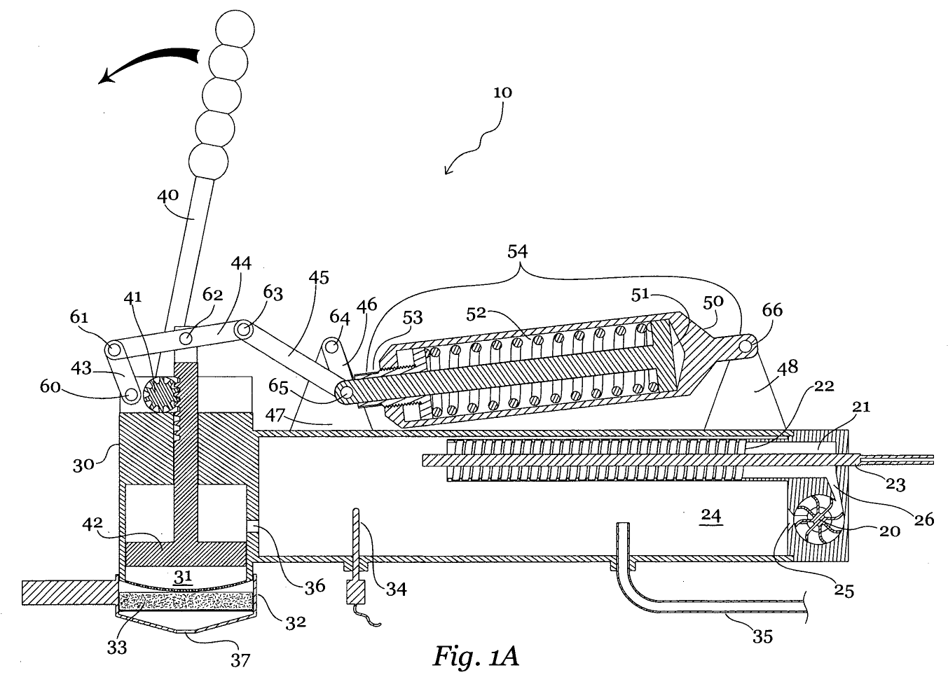

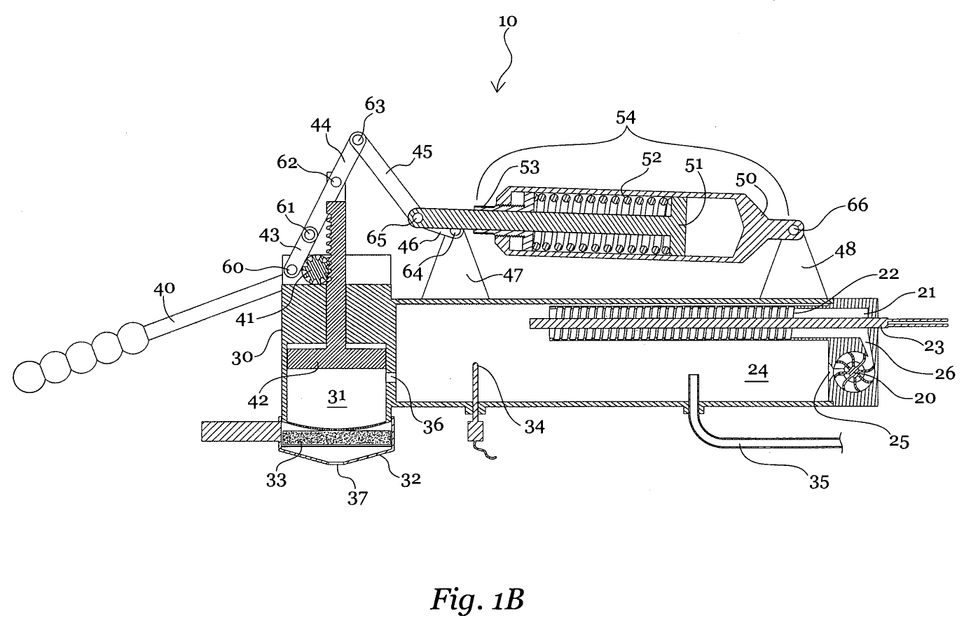

FIG. 1 illustrates an espresso coffee making apparatus, hereinafter referred to as “espresso machine”, indicated generally by the numeral 10. Such an espresso coffee making apparatus 10 includes a brew water tank 24 which may be cylindrical, prismatic, or any other shape suitable for containing the brewing water. Furthermore, in some instances, an espresso machine may employ a heat-exchanger design, where effectively, the brew water tank is small and submerged within another boiler, and heat is supplied from the encompassing boiler instead of from an active heating device engaged with the brew water tank, and one skilled in the art will appreciate that the concepts disclosed herein may be equally applicable to such a configuration. The espresso machine further comprising a heating device 23, a temperature sensing device 34 and a control system configured to maintain a constant temperature in the brew tank 24 based on an input from temperature sensing device 34 and activating heating device 23.

Thus far, the described elements are common to most commercially available espresso machines. The espresso machine 10 makes improvements on prior art by employing the following novel features. An actively driven impeller 20 is operatively engaged to the brew water tank 24, such that brew water is ingested at impeller intake port 25 and exhausted at impeller housing exit 26. Brew water flow from impeller 20 is further directed into housing 21 wherein turbulators 22 on the inside of housing 21 serve to further mix the brew water. Heating device 23 is disposed within the housing 21 to the effect that turbulent moving brew water is forced past heat source 23 such that superheated water immediately adjacent to the heat source 23 is quickly moved away and replaced with relatively cool water from within brew water tank 24. The further effect being that heat is more effectively and efficiently distributed within the water of brew tank 24 yielding two distinct advantages over prior art: the homogeneity of the temperature of the brew water within the tank is increased and recovery time, the time required to change the brew water from one temperature to another, is decreased. Greater homogeneity of the brew water allows the operator to produce more repeatable espresso extractions due to the lesser likelihood of temperature variation between and during brewing events. Short recovery time allows the operator to both produce a high frequency of coffee beverages, as well as minimizing the wait required should the operator make a change to the target brew water temperature.

Another novel aspect of the espresso machine 10 described below is the method in which it applies and regulates brew water pressure during the brewing process. FIG. 1A depicts the espresso machine 10 in the idle, ready-to-brew state. In order to brew espresso the operator must load a portafilter 32 containing roasted, ground, compacted, coffee beans 33 onto machine 10 (shown loaded and attached for clarification). Once the loaded portafilter 32 is attached the operator must pull the lever 40 anti-clockwise in figure (shown by arrow) from its position in FIG. 1A to its position in FIG. 1B. The lever 40 is rigidly attached to pinion gear 41 and the assembly of the two is free rotate about the axis of pinion gear 41. Anti clockwise rotation of the pinion gear 41 causes upward motion of piston 42 due to interaction with the gear rack cut into its shaft. When the piston 42 has risen above port 36 (see FIG. 1B) water flows into brew cylinder 31. Brew water flow into brew cylinder 32 is due to brew water tank 24 being maintained at a pressure of approximately 2 bar because brew water tank inlet 35 must be in fluid communication with regulated water mains or a suitable low pressure pump delivery system. Said connection is made at the time of installation by the installer or operator.

Another action which occurs simultaneously with the movement of the lever 40 and the piston 42 is the articulation of the at least one linkage device (in this embodiment the at least one linkage member comprises members 43-46) and subsequent energizing of the biasing device 54. The energy stored in the biasing device 54 is then used to drive the piston 42 downwards in a controlled manner during the brewing process.

The energizing and subsequent release process are described in detail as follows. The piston 42 is pivotally connected at the top of its shaft to linkage member 44 at point 62. The first end of linkage member 44 is pivotally connected to linkage member 43 at point 61, linkage member 43 being further pivotally anchored to brew body 30 at pivot point 60. The second side of link member 44 is pivotally connected to the first end of linkage member 45 at pivot point 63 and the second end of link member 45 is connected to the first end of biasing device 54 at pivot point 65. Pivot point 65 is pivotally constrained in space by link member 46, pivotally anchored at the first end to point 65 and the second end to axis point 64 which is rigidly held to brew body 30 by front pivot bracket 47. The second end of bias device 54 is pivotally anchored to rear pivot bracket 48 at axis point 66. Bias device 54 comprises housing 50 and slidingly engaged therein is bias piston 51. Bias member 52 (in this embodiment, a compression spring) is operatively engaged on its first end with bias piston 51 and on its second end with pre-load adjuster 53. Pre-load adjuster 53 is movably adjustable by means of an engaging thread in bias housing 50 such that biasing pre-load of bias member 52 can be adjusted by rotating pre-load adjuster 53 relative to bias housing 50. Bias device 54 is in this embodiment, effectively a tension spring system.

As piston 42 is raised in the manner previously described, member 44 is driven upward, its first end at point 61 being largely constrained by the short length of member 43, as a result the second end, point 63, moves up and away from bias device 54. Link member 45 connects point 63 of link member 44 and point 65 of bias device 54 however, the result being that bias device 54 is tensioned. As piston 42 reaches the op of its travel, near that position shown in FIG. 1B, axis points 64, 65, and 66 become co-linear. As a result all force exerted by bias device 54 is resisted by front bracket 47 via linkage member 46. At the position shown in FIG. 1B, point 65 has passed just beyond co-linear with 64 and 66, as further travel is mechanically prevented by the available travel of piston 42, the entire assembly achieves a stable equilibrium, no force is required for the operator to maintain handle 40 position. Further, in the position shown in FIG. 1B, port 36 is exposed to brew cylinder 31, brew water fills cylinder 31 and begins to gently wet the coffee grounds 33 in a so called “pre-infusion” process which allows the coffee to become thoroughly wetted before being exposed to high pressure. This results in a more optimal extraction with lesser likelihood of poor quality, uneven extraction due to fracture in the compressed, ground coffee.

Once the operator lifts the lever 40 from its position in FIG. 1B, the force exerted by bias device 54 is no longer fully counteracted by linkage member 46 and pivot bracket 47. Forces begin to travel through linkage members 45 and 44 into piston 42, forcing it downwards. As piston 42 lowers, port 36 is closed by the piston 42 and brew water chamber is exposed to pressure via the forces acting on brew piston 42. Piston 42 lowers further causing the volume of brew water chamber 31 to shrink, further forcing contained brew water to exit downwards through the compressed ground coffee 33, therein extracting and brewing espresso coffee, the finished beverage further being directed into the operator's cup via portafilter spout 37.

The relevant critical component of this extraction process is the pressure at which the brew water is introduced into the coffee grounds. This pressure is a function of the force supplied by bias device 54 and the geometric relationship of all the linkage members and piston previously described as one skilled in the art is able to understand. Furthermore one skilled in the art will recognize that in this embodiment the force applied to the piston, and therefore the pressure of the brew water, varies with the location of the piston, and still further that the brew pressure as a function of piston position can be modified by changes to the lengths and positions of the interacting components.

It should also be noted that the brew water pressurization system described above is adaptable and configurable to pump both hot, brew temperature water out of the brew boiler into the coffee bed, and also cold water into the brew pressure boiler and, as such, both such applications are within the scope of the present invention.

Many modifications and other embodiments of the invention set forth herein will come to mind to one skilled in the art to which this invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An espresso coffee making apparatus comprising:
at least one brew water tank to contain water to be used for brewing espresso;
at least one actively driven impeller mechanism operatively associated with the brew water such that motion imparted to the water by the at least one impeller mechanism has the effect of mixing and homogenizing the temperature of the brew water.

2. An apparatus according to claim 1 wherein the at least one impeller mechanism further comprises:
a housing to impart a substantially common direction to the exhaust of the at least one impeller mechanism;
at least one heat source operatively associated with the brew water within the housing.

3. An apparatus according to claim 2 further comprising at least one shape within the housing that has the effect of increasing the turbulence of the water moving within the housing.

4. An apparatus according to claim 1 further comprising;
at least one temperature sensing device operatively associated with the brew water;
at least one heat source operatively associated with the brew water;
a system capable of controlling the at least one heat source using input from the at least one temperature sensing device in such a way that the brew water is maintained at a substantially constant temperature.

5. An espresso coffee making apparatus comprising:
at least one member configured with a bore containing at least one incoming port and at least one outgoing port;
a piston operatively and movably engaged within each bore and configured to be capable of moving within the engaged bore between a first and a second position;
at least one valve in fluid communication with each bore configured such that when a piston is moved from the first position to the second position the swept volume in the bore is filled with water fed from the at least one incoming port, and further configured such that when the piston is moved from the second position to the first position the contained water is exhausted through the at least one outgoing port;
a lever mechanism operatively engaged to each piston and configured such that movement of the lever by the operator from a first to a second position drives the engaged piston from the first position to the second position;
a linkage mechanism, comprising at least one linkage member, having a first side operatively engaged to each piston and a second side operatively engaged to at least one biasing device, configured such that the bias applied to the second side by the at least one biasing device is delivered to the first side and has the effect of biasing the piston towards the first position, the linkage mechanism being further configured such that the mechanical advantage of the bias device on the linkage mechanism and the mechanical advantage of the linkage mechanism on the piston change as the piston moves from the second position to the first and to the further effect that the pressure exerted by the piston on the brew water due to said bias is controlled to a particular profile beneficial to brewing espresso as the piston travels from the second position to the first.

6. An apparatus according to claim 5 wherein the at least one biasing device is further configured to contain a bias pre-load adjustment device such that bias forces produced by the at least one biasing device can be shifted within a range of adjustment further, via the linkage mechanism and piston, shifting the brew pressure within some proportional range.

7. An apparatus according to claim 6 wherein the linkage mechanism is configured such that when the piston is in the second position the at least one linkage member exists in an over-center relationship with the at least one biasing device resulting in no force on the piston or lever, allowing the operator a no-effort pre-infusion stage, the linkage mechanism being further configured such that immediately after the lever is moved by the operator, the over-center relationship is lost and the at least one biasing device recommences acting on the piston via the linkage mechanism.

8. An apparatus according to claim 5 further comprising:
at least one brew water tank to contain water to be used for brewing espresso;
at least one actively driven impeller mechanism operatively associated with the brew water such that motion imparted to the water by the at least one impeller has the effect of mixing and homogenizing the temperature of the brew water, the at least one impeller further comprising:
a housing to impart a substantially common direction to the exhaust of the at least one impeller;
at least one heat source operatively associated with the brew water within the housing.

9. A method of operating an espresso machine comprising actively mixing water within a heated brew water tank to achieve substantial temperature homogeneity within the tank.

10. A method according to claim 9 further comprising:
pressurizing brew water within a cylinder being displaced by a piston moving within the cylinder, the piston being acted on by a biasing device via linkage mechanism, the biasing device being energized by the operator by means of a lever; and
controlling the pressure of the brew water as a function of brew water displaced by means of a changing mechanical advantage of the linkage mechanism transmitting the bias forces from the biasing device to the piston as the piston moves through its travel.

11. A method according to claim 10 further comprising adjusting the pre-load of the biasing device via an adjusting mechanism allowing a corresponding adjustment in brew pressure.
